(19) United States
(12) Patent Application Publication
(10) Pub. No.: US 2017/0063098 A1
(43) Pub. Date: Mar. 2, 2017

(54) INDUCTIVE AND CAPACITIVE WIRELESS POWER TRANSFER

(71) Applicant: QUALCOMM Incorporated, San Diego, CA (US)

(72) Inventors: Seong Heon Jeong, San Diego, CA (US); Ernest Tadashi Ozaki, Poway, CA (US); Linda Stacey Irish, San Diego, CA (US); William Henry Von Novak, III, San Diego, CA (US)

(21) Appl. No.: 14/838,404

(22) Filed: Aug. 28, 2015

(51) Int. Cl. H02J 5/00; H02J 7/02; H02J 17/00

(52) U.S. Cl. CPC H02J 5/005; H02J 17/00; H02J 7/025

(57) ABSTRACT

A wireless power transfer system includes an inductive transmit antenna, and a capacitive power transfer element, the inductive transmit antenna and the capacitive power transfer element configured to selectively provide inductive power transfer and selectively provide capacitive power transfer.

### FIELD

The present disclosure relates generally to wireless power. More specifically, the disclosure is directed to inductive and capacitive wireless power transfer.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections that require cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices may overcome some of the deficiencies of wired charging solutions. As such, wireless charging systems and methods that efficiently and safely transfer power for charging rechargeable electronic devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a wireless power transfer system including an inductive transmit antenna, and a capacitive power transfer element, the inductive transmit antenna and the capacitive power transfer element configured to selectively provide inductive power transfer and selectively provide capacitive power transfer.

Another aspect of the disclosure provides a wireless power transfer system including an inductive transmit antenna coupled to a first transmit circuit, and a first capacitive power transfer element coupled to a second transmit circuit, the inductive transmit antenna and the first capacitive power transfer element configured to selectively provide inductive power transfer and selectively provide capacitive power transfer, wherein in a first mode the inductive transmit antenna is configured to provide inductive power transfer and in a second mode the second transmit circuit is configured to alter a common mode of the first transmit circuit to generate a common mode signal between the inductive transmit antenna and the first capacitive power transfer element, such that the inductive transmit antenna is configured as a second capacitive power transfer element.

Another aspect of the disclosure provides a device for wireless power transfer including means for establishing a magnetic field coupling for selectively providing inductive power transfer, means for establishing an electric field coupling for selectively providing capacitive power transfer, and means for selectively providing inductive power transfer and capacitive power transfer.

Another aspect of the disclosure provides a method for wireless power transfer including establishing a magnetic field coupling for selectively providing inductive power transfer, establishing an electric field coupling for selectively providing capacitive power transfer, and selectively providing inductive power transfer and capacitive power transfer.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram of an exemplary wireless power transfer system, in accordance with exemplary embodiments of the invention.

FIG. 2 is a functional block diagram of exemplary components that may be used in the wireless power transfer system of FIG. 1, in accordance with various exemplary embodiments of the invention.

FIG. 3 is a schematic diagram of a portion of transmit circuitry or receive circuitry of FIG. 2 including a transmit or receive antenna, in accordance with exemplary embodiments of the invention.

FIG. 4 is a functional block diagram of a transmitter that may be used in the wireless power transfer system of FIG. 1, in accordance with exemplary embodiments of the invention.

FIG. 5 is a functional block diagram of a receiver that may be used in the wireless power transfer system of FIG. 1, in accordance with exemplary embodiments of the invention.

FIG. 6 is a schematic diagram of a portion of transmit circuitry that may be used in the transmit circuitry of FIG. 4.

FIG. 7 is a simplified diagram illustrating an exemplary embodiment of a wireless charging structure.

FIG. 8 is a simplified diagram illustrating the wireless charging structure of FIG. 7 including a charge-receiving device.

FIG. 9 is a simplified diagram illustrating an alternative exemplary embodiment of the wireless charging structure of FIG. 8.

FIG. 10 is a simplified diagram illustrating an alternative exemplary embodiment of the wireless charging structure of FIG. 8.

FIG. 11 is a diagram illustrating an exemplary embodiment of a transmit antenna that can be used with the wireless charging structures described herein.

FIG. 12A is a diagram illustrating an exemplary embodiment of a transmit antenna that can be used with the wireless charging structures described herein.

FIG. 12B is a diagram illustrating an exemplary embodiment of a transmit antenna that can be used with the wireless charging structures described herein.

FIG. 13 is a diagram illustrating an exemplary embodiment of a transmit antenna that can be used with the wireless charging structures described herein.

FIG. 14 is a schematic diagram showing an exemplary embodiment of a capacitive structure of FIG. 11, FIG. 12A, FIG. 12B and FIG. 13.

FIG. 15A is a schematic diagram showing an exemplary embodiment of a charge-receiving device configured to receive an electric field coupling.

FIG. 15B is a schematic diagram showing an exemplary embodiment of a charge-receiving device configured to receive an electric field coupling.

FIG. 16 is a schematic diagram showing an exemplary embodiment of a wireless charging system.

FIG. 17 is a schematic diagram showing an exemplary embodiment of a wireless charging system.

FIG. 18 is a schematic diagram showing an exemplary embodiment of a wireless charging system.

FIG. 19 is a schematic diagram showing an exemplary embodiment of a wireless power transmitter.

FIG. 20 is a flowchart illustrating an exemplary embodiment of a method for inductive and capacitive wireless power transfer.

FIG. 21 is a functional block diagram of an apparatus for inductive and capacitive wireless power transfer.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving antenna” to achieve power transfer.

Wireless charging systems can transfer charge to a charge receiving device by magnetic field coupling or by electric field coupling. A magnetic field coupling is also referred to as inductive coupling and generally uses what is referred to as an H-field coupling. An electrical field coupling is also referred to as capacitive coupling and generally uses what is referred to as an E-field coupling. Some devices are more efficiently charged using a magnetic field coupling and some devices are more efficiently charged using an electric field coupling. Therefore, it is desirable to have the ability to use either or both of a magnetic field coupling and an electric field coupling to charge a device.

Wireless induction chargers may use a magnetic field (H-field) coupling to transfer power to a receiver. However, there are some benefits to being able to transfer power via both a magnetic field coupling and via an electric field (E-field) coupling, or by having the ability to select either or both of a magnetic field coupling and an electric field coupling. In some circumstances, and for some charge-receiving devices, using an electric field coupling to transfer power has advantages over using a magnetic field coupling. For example, an electric field coupling generally works well with objects having a metal case, which may present difficulties when using a magnetic field coupling. An electric field coupling may potentially work better than a magnetic field coupling for wirelessly charging large objects, whereby certain smaller charge-receiving devices may be more compatible with magnetic field coupling.

A hybrid charging system can be configured to use either or both of capacitive charging (using electric, or E-field coupling) and inductive charging (using magnetic, or H-field coupling) to wirelessly charge devices. In an embodiment, the hybrid charging system can selectively switch between capacitive and inductive charging to wirelessly charge devices. In accordance with embodiments described herein, the wireless power transmitter can be configured to provide either or both of an E-field for capacitive charging and an H-field for inductive charging. A receiver can use either or both of capacitive charging and inductive charging for reception of power.

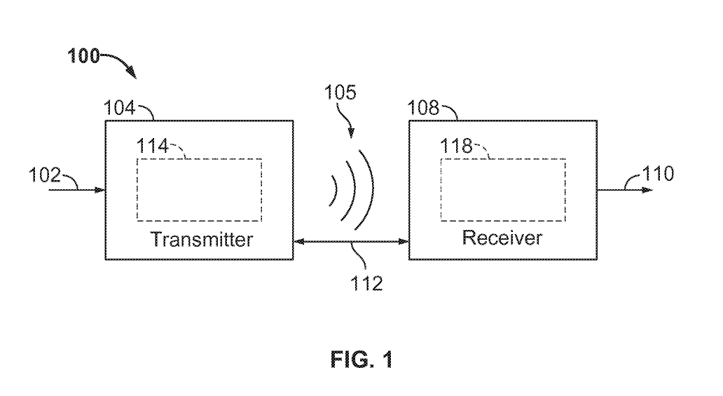

FIG. 1 is a functional block diagram of an exemplary wireless power transfer system 100, in accordance with exemplary embodiments of the invention. Input power 102 may be provided to a transmitter 104 from a power source (not shown) for generating a field 105 (e.g., magnetic or species of electromagnetic) for providing energy transfer. A receiver 108 may couple to the field 105 and generate output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship. When the resonant frequency of receiver 108 and the resonant frequency of transmitter 104 are substantially the same or very close, transmission losses between the transmitter 104 and the receiver 108 are reduced. As such, wireless power transfer may be provided over larger distances in contrast to purely inductive solutions that may require large coils to be very close (e.g., millimeters). Resonant inductive coupling techniques may thus allow for improved efficiency and power transfer over various distances and with a variety of inductive coil configurations.

The receiver 108 may receive power when the receiver 108 is located in an energy field 105 produced by the transmitter 104. The field 105 corresponds to a region where energy output by the transmitter 104 may be captured by a receiver 108. The transmitter 104 may include a transmit antenna 114 (that may also be referred to herein as a coil) for outputting an energy transmission. The receiver 108 further includes a receive antenna 118 (that may also be referred to herein as a coil) for receiving or capturing energy from the energy transmission. In some cases, the field 105 may correspond to the “near-field” of the transmitter 104. The near-field may correspond to a region in which there are strong reactive fields resulting from the currents and charges in the transmit antenna 114 that minimally radiate power away from the transmit antenna 114. In some cases the near-field may correspond to a region that is within about one wavelength (or a fraction thereof) of the transmit antenna 114.

In accordance with the above therefore, in accordance with more particular embodiments, the transmitter 104 may be configured to output a time varying magnetic field 105 with a frequency corresponding to the resonant frequency of the transmit antenna 114. When the receiver is within the field 105, the time varying magnetic field 105 may induce a voltage in the receive antenna 118 that causes an electrical current to flow through the receive antenna 118. As described above, if the receive antenna 118 is configured to be resonant at the frequency of the transmit antenna 114, energy may be more efficiently transferred. The AC signal induced in the receive antenna 118 may be rectified to produce a DC signal that may be provided to charge or to power a load.

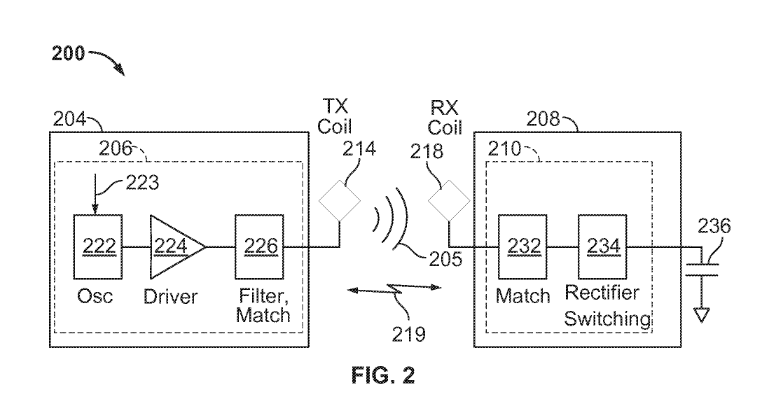

FIG. 2 is a functional block diagram of a wireless power transfer system 200 that includes exemplary components that may be used in the wireless power transfer system 100 of FIG. 1, in accordance with various exemplary embodiments of the invention. The transmitter 204 may include transmit circuitry 206 that may include an oscillator 222, a driver circuit 224, and a filter and matching circuit 226. The oscillator 222 may be configured to generate a signal at a desired frequency, such as 468.75 KHz, 6.78 MHz or 13.56 MHz, that may be adjusted in response to a frequency control signal 223. The oscillator signal may be provided to a driver circuit 224 configured to drive the transmit antenna 214 at, for example, a resonant frequency of the transmit antenna 214. The driver circuit 224 may be a switching amplifier configured to receive a square wave from the oscillator 222 and output a sine wave. For example, the driver circuit 224 may be a class E amplifier. A filter and matching circuit 226 may be also included to filter out harmonics or other unwanted frequencies and match the impedance of the transmitter 204 to the impedance of the transmit antenna 214. As a result of driving the transmit antenna 214, the transmitter 204 may wirelessly output power at a level sufficient for charging or powering an electronic device. As one example, the power provided may be for example on the order of 300 milliWatts to 5 Watts or 5 Watts to 40 Watts to power or charge different devices with different power requirements. Higher or lower power levels may also be provided.

The receiver 208 may include receive circuitry 210 that may include a matching circuit 232 and a rectifier and switching circuit 234 to generate a DC power output from an AC power input to charge a battery 236 as shown in FIG. 2 or to power a device (not shown) coupled to the receiver 208. The matching circuit 232 may be included to match the impedance of the receive circuitry 210 to the impedance of the receive antenna 218. The receiver 208 and transmitter 204 may additionally communicate on a separate communication channel 219 (e.g., Bluetooth, zigbee, cellular, etc). The receiver 208 and transmitter 204 may alternatively communicate via in-band signaling using characteristics of the wireless field 205.

The receiver 208 may initially have a selectively disablable associated load (e.g., battery 236), and may be configured to determine whether an amount of power transmitted by transmitter 204 and received by receiver 208 is appropriate for charging a battery 236. Further, receiver 208 may be configured to enable a load (e.g., battery 236) upon determining that the amount of power is appropriate.

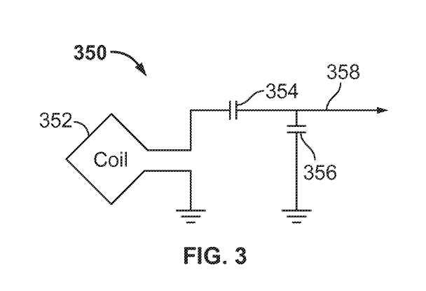

FIG. 3 is a schematic diagram of a portion of transmit circuitry 206 or receive circuitry 210 of FIG. 2 including a transmit or receive antenna 352, in accordance with exemplary embodiments of the invention. As illustrated in FIG. 3, transmit or receive circuitry 350 used in exemplary embodiments including those described below may include an antenna 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna 352 may also be referred to as a coil of a type that is configured to wirelessly output or receive power. As used herein, an antenna 352 is an example of a “power transfer component” of a type that is configured to wirelessly output and/or receive power. The antenna 352 may be configured to include an air core or a physical core such as a ferrite core (not shown).

The antenna 352 may form a portion of a resonant circuit configured to resonate at a resonant frequency. The resonant frequency of the loop or magnetic antenna 352 is based on the inductance and capacitance. Inductance may be simply the inductance created by the antenna 352, whereas, capacitance may be added to create a resonant structure (e.g., a capacitor may be electrically connected to the antenna 352 in series or in parallel) at a desired resonant frequency. As a non-limiting example, capacitor 354 and capacitor 356 may be added to the transmit or receive circuitry 350 to create a resonant circuit that resonates at a desired frequency of operation. For larger diameter antennas, the size of capacitance needed to sustain resonance may decrease as the diameter or inductance of the loop increases. As the diameter of the antenna increases, the efficient energy transfer area of the near-field may increase. Other resonant circuits formed using other components are also possible. As another non-limiting example, a capacitor (not shown) may be placed in parallel between the two terminals of the antenna 352. For transmit antennas, a signal 358 with a frequency that substantially corresponds to the resonant frequency of the antenna 352 may be an input to the antenna 352. For receive antennas, the signal 358 may be the output that may be rectified and used to power or charge a load.

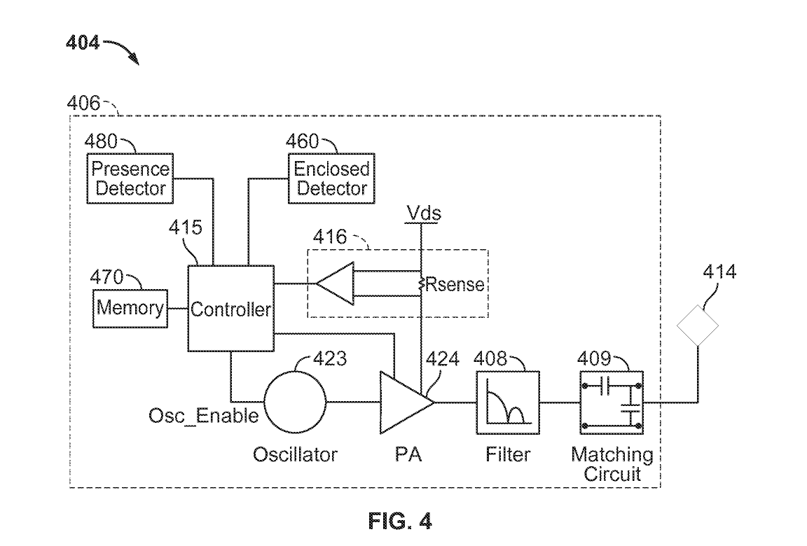

FIG. 4 is a functional block diagram of a transmitter 404 that may be used in the wireless power transfer system of FIG. 1, in accordance with exemplary embodiments of the invention. The transmitter 404 may include transmit circuitry 406 and a transmit antenna 414. The transmit antenna 414 may be the antenna 352 as shown in FIG. 3. The transmit antenna 414 may be configured as the transmit antenna 214 as described above in reference to FIG. 2. In some implementations, the transmit antenna 414 may be a coil (e.g., an induction coil). In some implementations, the transmit antenna 414 may be associated with a larger structure, such as a pad, table, mat, lamp, or other stationary configuration. Transmit circuitry 406 may provide power to the transmit antenna 414 by providing an oscillating signal resulting in generation of energy (e.g., magnetic flux) about the transmit antenna 414. Transmitter 404 may operate at any suitable frequency. By way of example, transmitter 404 may operate at the 6.78 MHz ISM band.

Transmit circuitry 406 may include a fixed impedance matching circuit 409 for matching the impedance of the transmit circuitry 406 (e.g., 50 ohms) to the impedance of the transmit antenna 414 and a low pass filter (LPF) 408 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that may be varied based on measurable transmit metrics, such as output power to the antenna 414 or DC current drawn by the driver circuit 424. Transmit circuitry 406 further includes a driver circuit 424 configured to drive a signal as determined by an oscillator 423. The transmit circuitry 406 may be comprised of discrete devices or circuits, or alternately, may be comprised of an integrated assembly.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as a processor. The controller 415 may be coupled to a memory 470. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit antenna 414. By way of example, a load sensing circuit 416 monitors the current flowing to the driver circuit 424, that may be affected by the presence or absence of active receivers in the vicinity of the field generated by transmit antenna 414 as will be further described below. Detection of changes to the loading on the driver circuit 424 are monitored by controller 415 for use in determining whether to enable the oscillator 423 for transmitting energy and to communicate with an active receiver.

The transmit antenna 414 may be implemented with a Litz wire or as an antenna strip with the thickness, width and metal type selected to keep resistive losses low.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert AC power present in a building, a DC-DC converter (not shown) to convert a DC power source to a voltage suitable for the transmitter 404, or directly from a DC power source (not shown).

As a non-limiting example, the presence detector 480 may be a motion detector utilized to sense the initial presence of a device to be charged that is inserted into the coverage area of the transmitter 404. After detection, the transmitter 404 may be turned on and the power received by the device may be used to toggle a switch on the receiver device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some exemplary embodiments, there may be regulations limiting the amount of power that a transmit antenna 414 may transmit at a specific frequency. In some cases, these regulations are meant to protect humans from electromagnetic radiation. However, there may be environments where a transmit antenna 414 is placed in areas not occupied by humans, or occupied infrequently by humans, such as, for example, garages, factory floors, shops, and the like. If these environments are free from humans, it may be permissible to increase the power output of the transmit antenna 414 above the normal power restrictions regulations. In other words, the controller 415 may adjust the power output of the transmit antenna 414 to a regulatory level or lower in response to human presence and adjust the power output of the transmit antenna 414 to a level above the regulatory level when a human is outside a regulatory distance from the wireless charging field of the transmit antenna 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 404 does not remain on indefinitely may be used. In this case, the transmitter 404 may be programmed to shut off after a user-determined amount of time. This feature prevents the transmitter 404, notably the driver circuit 424, from running long after the wireless devices in its perimeter are fully charged. This event may be due to the failure of the circuit to detect the signal sent from either the repeater or the receive antenna 218 that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

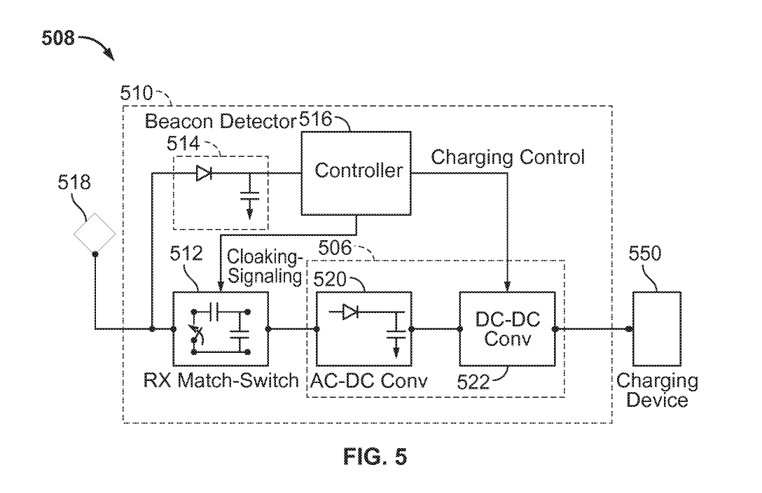

FIG. 5 is a functional block diagram of a receiver 508 that may be used in the wireless power transfer system of FIG. 1, in accordance with exemplary embodiments of the invention. The receiver 508 includes receive circuitry 510 that may include a receive antenna 518. Receiver 508 further couples to device 550 for providing received power thereto. It should be noted that receiver 508 is illustrated as being external to device 550 but may be integrated into device 550. Energy may be propagated wirelessly to receive antenna 518 and then coupled through the rest of the receive circuitry 510 to device 550. By way of example, the charging device may include devices such as mobile phones, portable music players, laptop computers, tablet computers, computer peripheral devices, communication devices (e.g., Bluetooth devices), digital cameras, hearing aids (and other medical devices), wearable devices, and the like.

Receive antenna 518 may be tuned to resonate at the same frequency, or within a specified range of frequencies, as transmit antenna 414 (FIG. 4). Receive antenna 518 may be similarly dimensioned with transmit antenna 414 or may be differently sized based upon the dimensions of the associated device 550. By way of example, device 550 may be a portable electronic device having diametric or length dimension smaller than the diameter or length of transmit antenna 414. In such an example, receive antenna 518 may be implemented as a multi-turn coil in order to reduce the capacitance value of a tuning capacitor (not shown) and increase the receive coil's impedance. By way of example, receive antenna 518 may be placed around the substantial circumference of device 550 in order to maximize the antenna diameter and reduce the number of loop turns (i.e., windings) of the receive antenna 518 and the inter-winding capacitance.

Receive circuitry 510 may provide an impedance match to the receive antenna 518. Receive circuitry 510 includes power conversion circuitry 506 for converting received energy into charging power for use by the device 550. Power conversion circuitry 506 includes an AC-to-DC converter 520 and may also include a DC-to-DC converter 522. AC-to-DC converter 520 rectifies the energy signal received at receive antenna 518 into a non-alternating power with an output voltage. The DC-to-DC converter 522 (or other power regulator) converts the rectified energy signal into an energy potential (e.g., voltage) that is compatible with device 550 with an output voltage and output current. Various AC-to-DC converters are contemplated, including partial and full rectifiers, regulators, bridges, doublers, as well as linear and switching converters.

Receive circuitry 510 may further include RX matching and switching circuitry 512 for connecting receive antenna 518 to the power conversion circuitry 506 or alternatively for disconnecting the power conversion circuitry 506. Disconnecting receive antenna 518 from power conversion circuitry 506 not only suspends charging of device 550, but also changes the “load” as “seen” by the transmitter 404 (FIG. 2).

When multiple receivers 508 are present in a transmitter's near-field, it may be desirable to adjust the loading and unloading of one or more receivers to enable other receivers to more efficiently couple to the transmitter. A receiver 508 may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 may provide a communication mechanism from receiver 508 to transmitter 404. Additionally, a protocol may be associated with the switching that enables the sending of a message from receiver 508 to transmitter 404. By way of example, a switching speed may be on the order of 100 μsec.

In an exemplary embodiment, communication between the transmitter 404 and the receiver 508 may take place either via an “out-of-band” separate communication channel/antenna or via “in-band” communication that may occur via modulation of the field used for power transfer.

Receive circuitry 510 may further include signaling detector and beacon circuitry 514 used to identify received energy fluctuations that may correspond to informational signaling from the transmitter to the receiver. Furthermore, signaling and beacon circuitry 514 may also be used to detect the transmission of a reduced signal energy (i.e., a beacon signal) and to rectify the reduced signal energy into a nominal power for awakening either un-powered or power-depleted circuits within receive circuitry 510 in order to configure receive circuitry 510 for wireless charging.

Receive circuitry 510 further includes controller 516 for coordinating the processes of receiver 508 described herein including the control of RX matching and switching circuitry 512 described herein. It is noted that the controller 516 may also be referred to herein as a processor. Cloaking of receiver 508 may also occur upon the occurrence of other events including detection of an external wired charging source (e.g., wall/USB power) providing charging power to device 550. Controller 516, in addition to controlling the cloaking of the receiver, may also monitor beacon circuitry 514 to determine a beacon state and extract messages sent from the transmitter 404. Controller 516 may also adjust the DC-to-DC converter 522 for improved performance.

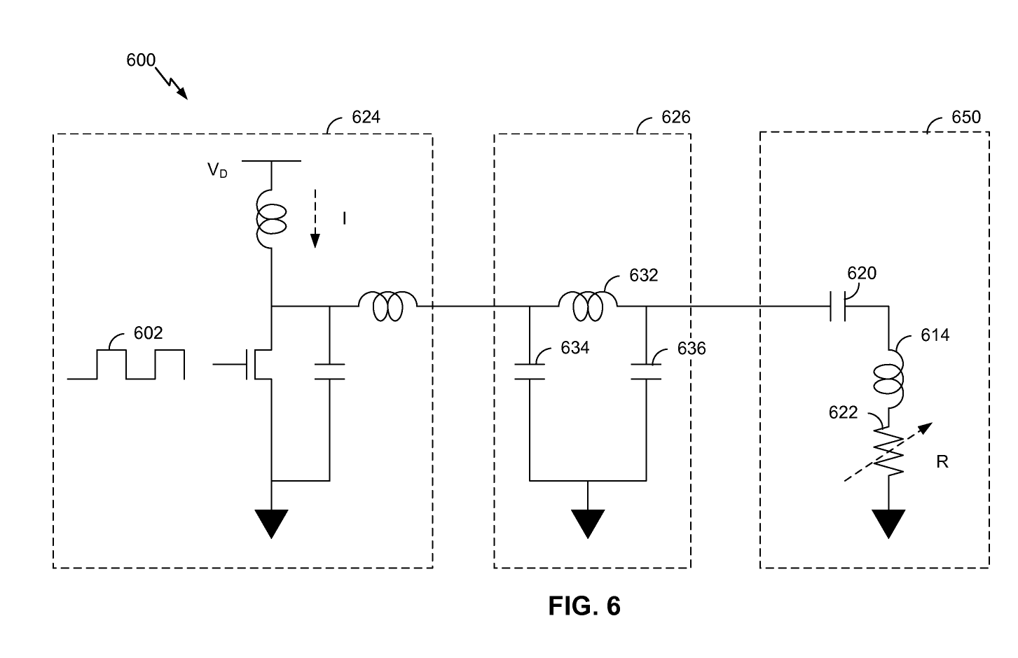

FIG. 6 is a schematic diagram of a portion of transmit circuitry 600 that may be used in the transmit circuitry 406 of FIG. 4. The transmit circuitry 600 may include a driver circuit 624 as described above in FIG. 4. As described above, the driver circuit 624 may be a switching amplifier that may be configured to receive a square wave and output a sine wave to be provided to the transmit circuit 650. In some cases the driver circuit 624 may be referred to as an amplifier circuit. The driver circuit 624 is shown as a class E amplifier, however, any suitable driver circuit 624 may be used in accordance with embodiments of the invention. The driver circuit 624 may be driven by an input signal 602 from an oscillator 423 as shown in FIG. 4. The driver circuit 624 may also be provided with a drive voltage V_{D} that is configured to control the maximum power that may be delivered through a transmit circuit 650. To eliminate or reduce harmonics, the transmit circuitry 600 may include a filter circuit 626. The filter circuit 626 may be a three pole (capacitor 634, inductor 632, and capacitor 636) low pass filter circuit 626.

The signal output by the filter circuit 626 may be provided to a transmit circuit 650 comprising an antenna 614. The transmit circuit 650 may include a series resonant circuit having a capacitance 620 and inductance (e.g., that may be due to the inductance or capacitance of the antenna or to an additional capacitor component) that may resonate at a frequency of the filtered signal provided by the driver circuit 624. The load of the transmit circuit 650 may be represented by the variable resistor 622. The load may be a function of a wireless power receiver 508 that is positioned to receive power from the transmit circuit 650.

In an exemplary embodiment, it is desirable to have the ability to provide charging power or charging energy to a charge-receiving device using capacitive charging (using electric, or E-field coupling) and inductive charging (using magnetic, or H-field coupling) either alternatively or simultaneously to transfer power to a charge-receiving device.

In an exemplary embodiment, is desirable to have the ability to selectively provide charging power or charging energy to a charge-receiving device using capacitive charging (using electric, or E-field coupling) or inductive charging (using magnetic, or H-field coupling).

In an exemplary embodiment, capacitive elements can be added to a wireless power transmitter that is primarily used for inductive power transfer to allow simultaneous inductive and capacitive, or selective inductive and capacitive wireless power transfer.

In an exemplary embodiment, portions of an inductive transmit resonator that have capacitive properties can be used to provide capacitive power transfer.

In an exemplary embodiment, capacitive elements can be added to an inductive transmit resonator can be used to provide capacitive power transfer.

In an exemplary embodiment, capacitive portions of a charge-receiving device can be used to provide capacitive power transfer.

In an exemplary embodiment, capacitive elements can be added to a charge-receiving device to provide capacitive power transfer.

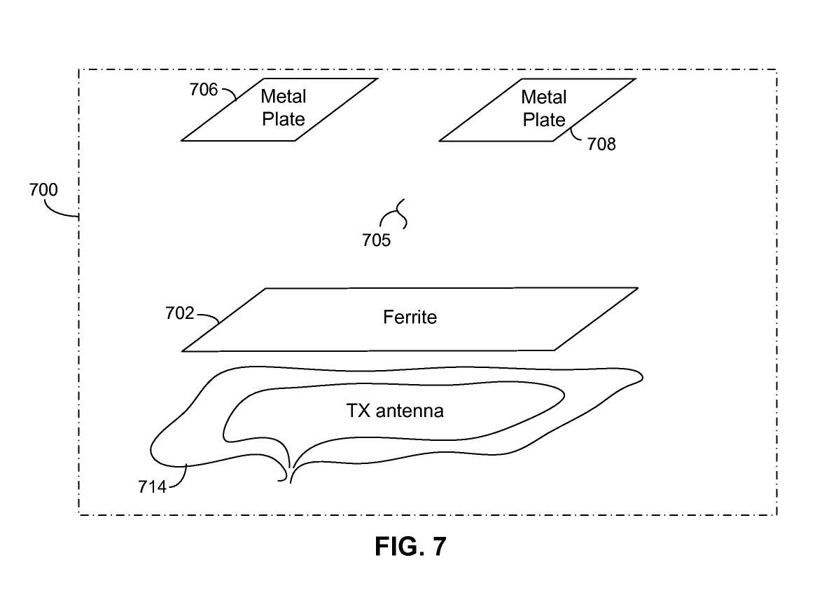

FIG. 7 is a simplified diagram illustrating an exemplary embodiment of a wireless charging structure 700. The wireless charging structure 700 can be associated with, or can be a portion of a pad, table, mat, lamp, or other element associated with a wireless charging system. In an embodiment, the wireless charging structure 700 may be referred to as a pad having a wireless charging surface 705 on which a charge-receiving device may be placed to wirelessly receive power. In an exemplary embodiment, the wireless charging structure 700 comprises a transmit antenna 714, a ferrite element 702, and metal plates 706 and 708. The transmit antenna 714 may comprise part of a resonant structure as described above with respect to FIG. 3 and FIG. 4 for use as a transmit resonator, a transmit antenna, or a transmit coil to provide inductive wireless power transfer. A receive antenna with an associated capacitance can be configured to resonate at or near the same resonant frequency as the transmit antenna 714 and can efficiently receive power over a magnetic field (H-field) coupling established between the transmit antenna 714 and a receive antenna.

The ferrite element 702 magnetically shields the metal plates 706 and 708 from a magnetic field generated by the transmit antenna 714. Thus, the transmit antenna 714 does not induce an eddy current in the metal plates 706 and 708 and does not disturb any current in the metal plates 706 and 708 when the metal plates 706 and 708 are configured to enable wireless capacitive power transfer. The metal plate 706 and the metal plate 708 each form one of the conductors, or plates, of two capacitors. Corresponding metal plates in a charge-receiving device form the other conductors, or plates of the two capacitors, thus forming two capacitors that can be configured to enable wireless capacitive power transfer. The ferrite element 702 magnetically isolates the transmit antenna 714 from the metal plate 706 and the metal plate 708 and also increases mutual inductance when providing wireless inductive power transfer. The ferrite element 702 also shields the metal plate 706 and the metal plate 708 from magnetic flux generated by the transmit antenna 714.

The position of the ferrite element 702 and the transmit antenna 714 can be reversed. Further, the ferrite element 702 and the metal plates 708 and 708 can be formed on the opposite side of the transmit antenna 714. Although generally shown as the ferrite element 702 being formed “over” the transmit antenna 714, and the metal plates 706 and 708 being formed “over” the ferrite element 702, the orientation of the elements shown in FIG. 7, and the alternative embodiments shown herein, are intended to be illustrative examples only. For example, in an application where it may be advantageous to enhance inductive wireless power transfer, the metal plates 706 and 708 may be located “below” the transmit antenna 714.

Resonant capacitors (not shown) that may be coupled to the transmit antenna 714 to allow the transmit antenna 714 to operate as a resonant circuit are omitted form FIG. 7 for simplicity. Further, the electrical coupling between the metal plate 706 and the metal plate 708 and the output of the transmit circuitry 406 (FIG. 4) are also omitted for simplicity. As will be described in greater detail below, the metal plate 706 and the metal plate 708 may be coupled to the output of the transmit circuitry 406 (FIG. 4) either before or after the resonant capacitors (not shown), depending on the application.

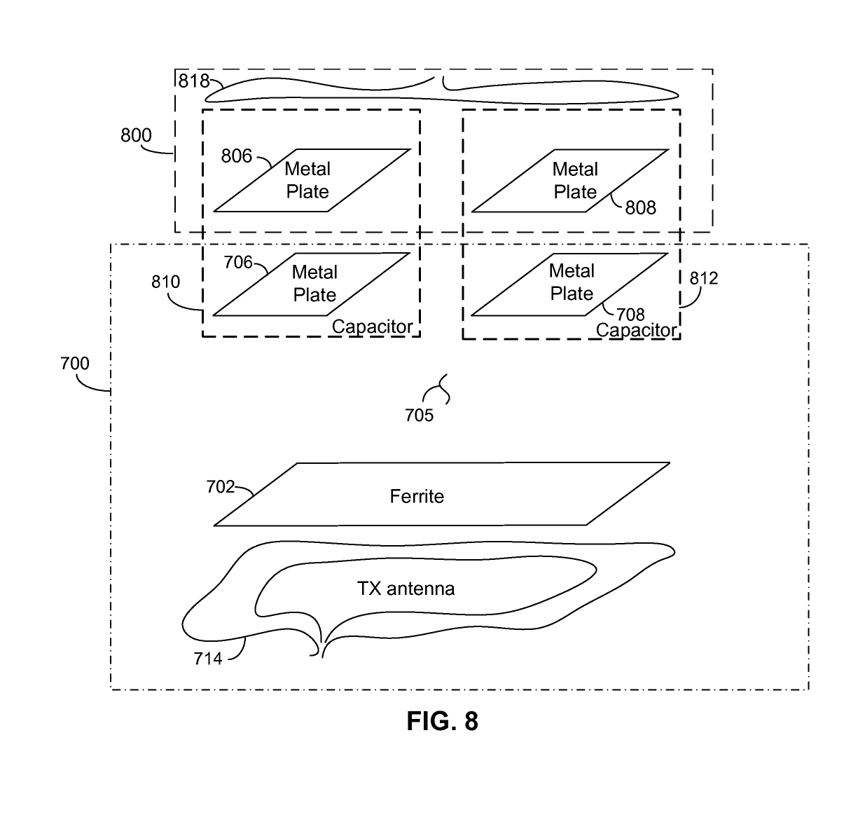

FIG. 8 is a simplified diagram illustrating the wireless charging structure of FIG. 7 including a charge-receiving device 800. The wireless charging structure 700 shown in FIG. 7 is repeated in FIG. 8; however, FIG. 8 also includes a charge-receiving device 800. In an exemplary embodiment, the charge-receiving device 800 can be an embodiment of the receiver 508 shown in FIG. 5. Details of the charge-receiving device 800 are omitted from FIG. 8 for simplicity of illustration. In an exemplary embodiment, the charge-receiving device 800 comprises metal plates 806 and 808. The metal plate 706 and the metal plate 806 form a capacitor 810. The metal plate 708 and the metal plate 808 form a capacitor 812. In an exemplary embodiment, a high-permittivity dielectric can be located between each of the metal plates 706 and 708 and the corresponding metal plates 806 and 808 in the charge-receiving device 800 to increase the capacitance of the capacitors 810 and 812. In an exemplary embodiment, any or all of the material that forms the housing or enclosure of the wireless charging structure 700 or the material that forms the housing or enclosure of the charge-receiving device 800 may form the dielectric for the capacitor 810 and the capacitor 812. In an exemplary embodiment, a dielectric material other than the material that forms the housing or enclosure of the wireless charging structure 700 or of the charge-receiving device 800 may form the dielectric for the capacitor 810 and the capacitor 812. For example, a separate dielectric material may be located between each metal plate 706 and 708 and the housing or enclosure of the wireless charging structure 700, or a separate dielectric material may be located between each metal plate 806 and 808 and the housing or enclosure of the charge-receiving device 800. In an exemplary embodiment, the dielectric for the capacitors 810 and 812 may be formed by the air between the metal plates 706 and 806, and between the metal plates 708 and 808. In an exemplary embodiment, the size and the electrical properties of the dielectric of the capacitors 810 and 812 may depend on the size of a given capacitive charging area.

Moreover, it is desirable to maximize the electrical isolation between the metal plates 706 and 708. For example, the permittivity of a dielectric located between the metal plates 706 and 708 may be as small as possible in order to maximize isolation and minimize leakage power between the metal plates 706 and 708. In an exemplary embodiment where there is an airgap between the metal plates 706 and 708 a separate dielectric is typically not used.

The capacitors 810 and 812 can be configured to provide wireless capacitive power transfer by allowing the establishment of an electric field (E-field) coupling between the wireless charging structure 700 and the charge-receiving device 800. In an exemplary embodiment, the metal plates 706 and 708 of the two capacitors 810 and 812 are driven by the transmit circuitry 406 (e.g., the oscillator 423) with an alternating voltage in opposite phase, such that the alternating electric fields induce opposite phase alternating potentials in the corresponding metal plates 806 and 808 in the charge-receiving device 800. This causes current to flow through the capacitors 810 and 812, and also through a load coupled to the metal plates 806 and 808 in the charge-receiving device 800. In an exemplary embodiment, the charge-receiving device 800 also comprises a receive antenna 818 configured to receive inductive charging energy from the transmit antenna 714. The receive antenna 818 can be an embodiment of the receive antenna 518 described with respect to FIG. 5. The electrical connections from the metal plates 806 and 808 to the receive circuitry (FIG. 5), and the electrical connections from the receive antenna 818 to the receive circuitry (FIG. 5) are omitted from FIG. 8 for simplicity.

In an exemplary embodiment, the transmit antenna 714 and the receive antenna 818 can be configured to operate as a resonant tuned circuit resonating at or near the same resonant frequency so as to establish a magnetic field (H-field) coupling between the wireless charging structure 700 and the charge-receiving device 800. In an exemplary embodiment, an electric field (E-field) coupling between the wireless charging structure 700 and the charge-receiving device 800 can exist simultaneously with the magnetic field (H-field) coupling between the wireless charging structure 700 and the charge-receiving device 800. In an alternative embodiment, the electric field (E-field) coupling between the wireless charging structure 700 and the charge-receiving device 800 can exist independently from the magnetic field (H-field) coupling between the wireless charging structure 700 and the charge-receiving device 800; and the magnetic field (H-field) coupling between the wireless charging structure 700 and the charge-receiving device 800 can exist independently from the electric field (E-field) coupling between the wireless charging structure 700 and the charge-receiving device 800. In an exemplary embodiment, the charge-receiving device 800 may be located on the wireless charging surface 705 and the inductive transmit antenna 714 may be configured to generate a magnetic field for charging the charge-receiving device 800 anywhere on the wireless charging surface 705, and the metal plate 806 and the metal plate 808 form a capacitive charging area on the wireless charging surface 705.

In an exemplary embodiment, a combination of the dielectric, the size of the metal plates 706 and 708, and the size of the metal plates 806 and 808 influences the amount of capacitance provided by the capacitors 810 and 812. This in turn influences the amount of power that can be transferred using the electric field (E-field) coupling between the wireless charging structure 700 and the charge-receiving device 800.

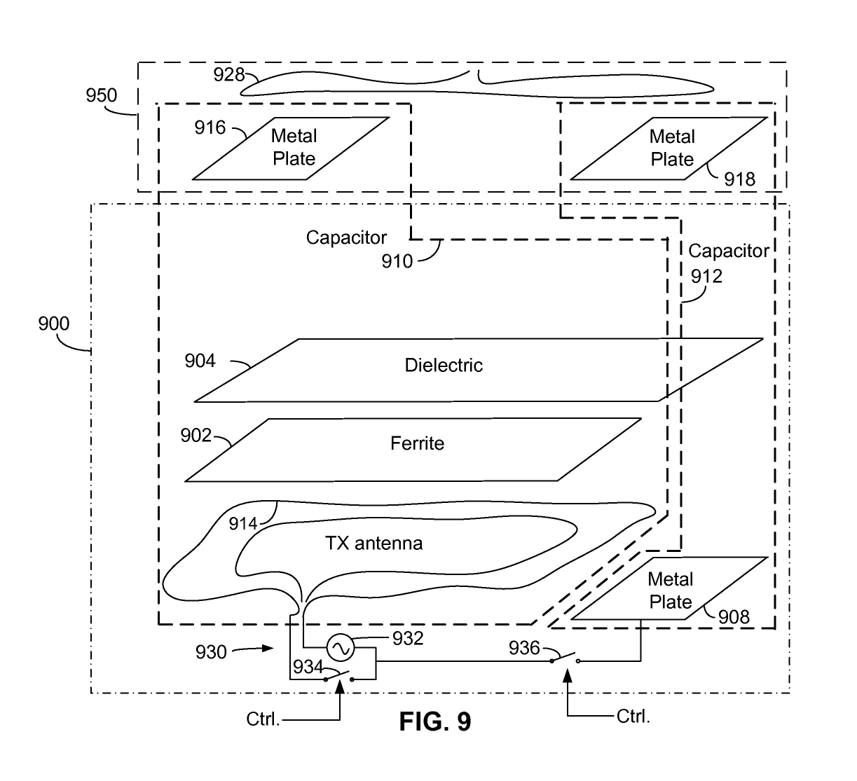

FIG. 9 is a simplified diagram illustrating an alternative exemplary embodiment of the wireless charging structure of FIG. 8. The wireless charging structure 900 is similar to the wireless charging structure 700. In an exemplary embodiment, the wireless charging structure 900 comprises a transmit antenna 914, a ferrite element 902, a dielectric element 904 and a metal plate 908. The transmit antenna 914 may comprise part of a resonant structure as described above with respect to FIG. 3 and FIG. 4 for use as a transmit resonator, a transmit antenna, or a transmit coil, to provide inductive wireless power transfer. In an exemplary embodiment, the wireless charging structure 900 also comprises a circuit 930 comprising a power source 932, a switch 934 and a switch 936. The switches 934 and 936 may receive respective control signals from the controller 415 (FIG. 4).

FIG. 9 also includes a charge-receiving device 950. In an exemplary embodiment, the charge-receiving device 950 can be an embodiment of the receiver 508 shown in FIG. 5. Details of the charge-receiving device 950 are omitted from FIG. 9 for simplicity of illustration. The charge-receiving device 950 comprises metal plates 916 and 918. In an exemplary embodiment, the charge-receiving device 950 also comprises a receive antenna 928 configured to receive inductive charging energy from the transmit antenna 914. The receive antenna 928 can be an embodiment of the receive antenna 518 described with respect to FIG. 5. In an exemplary embodiment, the transmit antenna 914 and the receive antenna 928 can be configured to operate as a resonant tuned circuit resonating at or near the same resonant frequency so as to establish a magnetic field (H-field) coupling between the wireless charging structure 900 and the charge-receiving device 950.

In an exemplary embodiment, in a first mode when the switch 934 is closed and the switch 936 is open the transmit antenna 914 may be configured to provide inductive wireless power transfer, and in a second mode when the switch 934 is open and the switch 936 is closed, the transmit antenna 914 may be configured as a capacitive element that can form one of the plates of a capacitor 910, with the other plate of the capacitor 910 being the metal plate 916. In an exemplary embodiment where the transmit antenna 914 may be configured as a capacitive element that can form one of the plates of a capacitor 910, the dielectric 904 may form the dielectric for the capacitor 910. In this exemplary embodiment, the dielectric 904 may increase the capacitance between the transmit antenna 914 and the metal plate 916 when the transmit antenna 914 is used for capacitive charging. When the switch 934 is closed and the switch 936 is open, the transmit antenna 914 operates at a resonant frequency as described above such that a magnetic (H-field) coupling may be established between the transmit antenna 914 and the receive antenna 928.

When the switch 934 is open and the switch 936 is closed, the transmit antenna 914 and the metal plate 916 form a capacitor 910; and the metal plate 908 and the metal plate 918 form a capacitor 912. In an exemplary embodiment, the dielectric 904 also forms the dielectric between the metal plate 908 and the metal plate 918. The capacitors 910 and 912 can be configured to provide wireless capacitive power transfer by allowing the establishment of an electric field (E-field) coupling between the wireless charging structure 900 and the charge-receiving device 950. In an exemplary embodiment, a combination of the dielectric 904 and the size of the transmit antenna 914 and the metal plate 916, and the size of the metal plates 908 and 918 influence the amount of capacitance provided by the capacitors 910 and 912. Although shown as a single dielectric 904 forming the dielectric for the capacitors 910 and 912, in an alternative exemplary embodiment, the capacitors 910 and 912 may have separate dielectrics.

In an exemplary embodiment, in a first mode, the transmit antenna 914 and the receive antenna 928 can be configured to operate as a resonant tuned circuit resonating at or near the same resonant frequency so as to establish a magnetic field (H-field) coupling between the wireless charging structure 900 and the charge-receiving device 950. In an exemplary embodiment, in a second mode, the capacitors 910 and 912 can be configured to provide wireless capacitive power transfer by allowing the establishment of an electric field (E-field) coupling between the wireless charging structure 900 and the charge-receiving device 950. In an exemplary embodiment, the electric field (E-field) coupling between the wireless charging structure 900 and the charge-receiving device 950 can exist independently from the magnetic field (H-field) coupling between the wireless charging structure 900 and the charge-receiving device 950; and the magnetic field (H-field) coupling between the wireless charging structure 900 and the charge-receiving device 950 can exist independently from the electric field (E-field) coupling between the wireless charging structure 900 and the charge-receiving device 950, responsive to the position of the switch 934 and the switch 936.

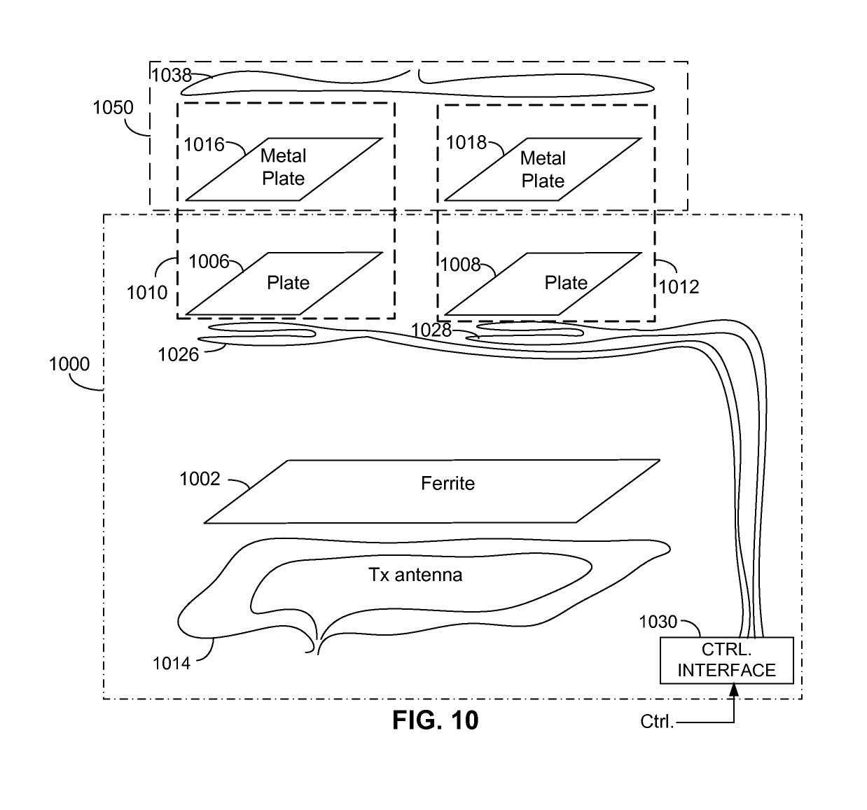

FIG. 10 is a simplified diagram illustrating an alternative exemplary embodiment of the wireless charging structure of FIG. 8. The wireless charging structure 1000 is similar to the wireless charging structure 700. In an exemplary embodiment, the wireless charging structure 1000 comprises a transmit antenna 1014, a ferrite element 1002 and plates 1006 and 1008. In an exemplary embodiment, the plates 1006 and 1008 can be formed using a selectively conductive material. A selectively conductive material is one that can be switched between an electrically conductive state and an electrically non-conductive state. For example, the plates 1006 and 1008 can be formed using a DC-enabled material or a DC static H-field enabled material that can be used to selectively control the electrical conductivity of the plates 1006 and 1008 in one or more directions. In an exemplary embodiment, a coil 1026 is formed in proximity to the plate 1006 and a coil 1028 is formed in proximity to the plate 1008. The coils 1026 and 1026 may be coupled to a control interface 1030, which may receive a control signal from a controller, such as the controller 415 in FIG. 4. In an exemplary embodiment, the plates 1006 and 1008 can be formed using a DC-enabled material, the electrical conductivity of which can be controlled by an electrical current flowing in the coil 1026 and the coil 1028, or a magnetic field established by the coil 1026 and the coil 1028 responsive to a control signal from the controller 415 through the control interface 1030. For example, when the plates 1006 and 1008 are formed using a DC-enabled material to control their electrical conductivity, and the DC-enabled material forming the plates 1006 and 1008 is non-conductive, then the system can provide wireless inductive power transfer (H-field only) using the transmit antenna 1014. When the DC-enabled material forming the plates 1006 and 1008 is conductive, then the system can provide wireless capacitive power transfer using the plates 1006 and 1008 as respective first capacitor plates and the metal plates 1016 and 1018 as respective second capacitor plates of respective capacitors 1010 and 1012. The transmit antenna 1014 may comprise part of a resonant structure as described above with respect to FIG. 3 and FIG. 4 for use as a transmit resonator, or transmit antenna, or transmit coil to provide inductive wireless power transfer.

FIG. 10 also includes a charge-receiving device 1050. In an exemplary embodiment, the charge-receiving device 1050 can be an embodiment of the receiver 508 shown in FIG. 5. Details of the charge-receiving device 1050 are omitted from FIG. 10 for simplicity of illustration. The charge-receiving device 1050 comprises metal plates 1016 and 1018. In an exemplary embodiment, the charge-receiving device 1050 also comprises a receive antenna 1038 configured to receive inductive charging energy from the transmit antenna 1014. The receive antenna 1038 can be an embodiment of the receive antenna 518 described with respect to FIG. 5. In an exemplary embodiment, the transmit antenna 1014 and the receive antenna 1038 can be configured to operate as a resonant tuned circuit resonating at or near the same resonant frequency so as to establish a magnetic field (H-field) coupling between the wireless charging structure 1000 and the charge-receiving device 1050.

In an exemplary embodiment, a high-permittivity dielectric can be located between each of the plates 1006 and 1008 and the corresponding metal plates 1016 and 1018 in the charge-receiving device 1050 to increase the capacitance of the capacitors 1010 and 1012. In an exemplary embodiment, any or all of the material that forms the housing or enclosure of the wireless charging structure 1000 or the material that forms the housing or enclosure of the charge-receiving device 1050 may form the dielectric for the capacitor 1010 and the capacitor 1012. In an exemplary embodiment, a dielectric material other than the material that forms the housing or enclosure of the wireless charging structure 1000 or of the charge-receiving device 1050 may form the dielectric for the capacitor 1010 and the capacitor 1012. For example, a separate dielectric material may be located between each plate 1006 and 1008 and the housing or enclosure of the wireless charging structure 1000, or a separate dielectric material may be located between each metal plate 1016 and 1018 and the housing or enclosure of the charge-receiving device 1050. In an exemplary embodiment, the dielectric for the capacitors 1010 and 1012 may be formed by the air between the plate 1006 and the metal plate 1016, and between the plate 1008 and the metal plate 1018. In an exemplary embodiment, the size and the electrical properties of the dielectric of the capacitors 1010 and 1012 may depend on the size of a given capacitive charging area.

In an exemplary embodiment, in a first mode when the plates 1006 and 1008 are selectively controlled to be electrically non-conductive, the transmit antenna 1014 may be configured to provide wireless inductive power transfer, and in a second mode when the plates 1006 and 1008 are selectively controlled to be electrically conductive, the plate 1006 and the metal plate 1016 form a capacitor 1010; and the plate 1008 and the metal plate 1018 form a capacitor 1012. The capacitors 1010 and 1012 can be configured to provide wireless capacitive power transfer to the charge-receiving device 1050 by allowing the establishment of an electric field (E-field) coupling between the wireless charging structure 1000 and the charge-receiving device 1050.

In an alternative exemplary embodiment, the plates 1006 and 1008 can be formed using a DC H-field material, the conductivity of which can be controlled by the establishment of a DC H-field in the vicinity of the plates 1006 and 1008. Because the magnetic field coupling between the transmit antenna 1014 and the receive antenna 1038 is established using an AC H-field, the AC H-field does not influence the conductivity of the DC H-field material.

In an exemplary embodiment, in a first mode, the transmit antenna 1014 and the receive antenna 1038 can be configured to operate as a resonant tuned circuit resonating at or near the same resonant frequency so as to establish a magnetic field (H-field) coupling between the wireless charging structure 1000 and the charge-receiving device 1050. In an exemplary embodiment, in a second mode, the capacitors 1010 and 1012 can be configured to provide wireless capacitive power transfer by allowing the establishment of an electric field (E-field) coupling between the wireless charging structure 1000 and the charge-receiving device 1050. In an exemplary embodiment, the electric field (E-field) coupling between the wireless charging structure 1000 and the charge-receiving device 1050 can exist independently from the magnetic field (H-field) coupling between the wireless charging structure 1000 and the charge-receiving device 1050; and the magnetic field (H-field) coupling between the wireless charging structure 1000 and the charge-receiving device 1050 can exist independently from the electric field (E-field) coupling between the wireless charging structure 1000 and the charge-receiving device 1050, responsive to the control signal from the controller 415.

In an exemplary embodiment, the magnetic field (H-field) coupling between the wireless charging structure 1000 and the charge-receiving device 1050 can be established simultaneously with the electric field (E-field) coupling between the wireless charging structure 1000 and the charge-receiving device 1050.

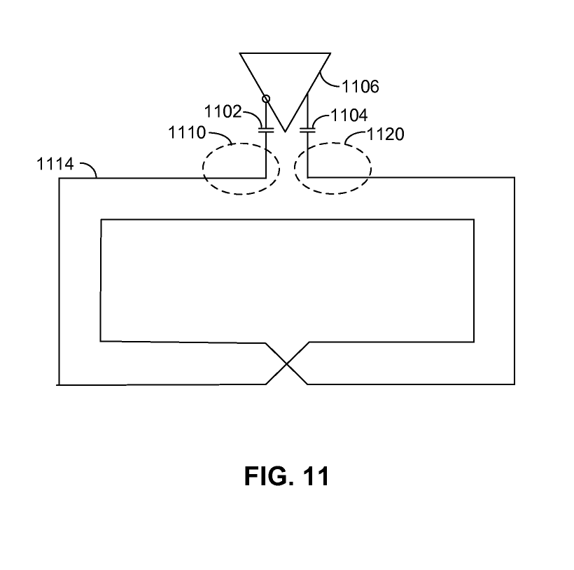

FIG. 11 is a diagram illustrating an exemplary embodiment of a transmit antenna 1114 that can be used with the wireless charging structures described herein. The transmit antenna 1114 is coupled to transmit circuitry 1106 via resonant capacitors 1102 and 1104. The transmit circuitry 1106 can be an embodiment of the transmit circuitry 406 described in FIG. 4. The transmit antenna 1114 is shown in FIG. 11 as a coil having two “turns” or “windings.” However, other configurations are possible. The resonant capacitors 1102 and 1104, together with the transmit antenna 1114 may create a resonant structure that resonates at a desired resonant frequency. In the example shown in FIG. 11, the resonant capacitors 1102 and 1104, together with the transmit antenna 1114 create a series-resonant circuit. However, in alternative embodiments, the resonant capacitors 1102 and 1104, and the transmit antenna 1114 may be coupled as a parallel-resonant circuit.

In an exemplary embodiment, the transmit antenna 1114, when operating as an inductive resonator, may generate one or more electric fields (E-fields) that may be used to create one or more electric field (E-field) couplings with a respective receive element (not shown). As an example only, the transmit antenna 1114 may have an inherently capacitive portion configured to generate an electric field in the regions denoted as 1110 and 1120 that may be stronger than an electric field generated in regions of the transmit antenna 1114 other than the regions 1110 and 1120. In an exemplary embodiment, the electric field generated in the regions 1110 and 1120 can be generated with no additional structures or capacitive elements added to the transmit antenna 1114, but instead, may be generated as part of the resonant inductive operation of the transmit antenna 1114. The electric field generated by the transmit antenna 1114 in the regions 1110 and 1120 may be used for wireless capacitive power transfer as described above.

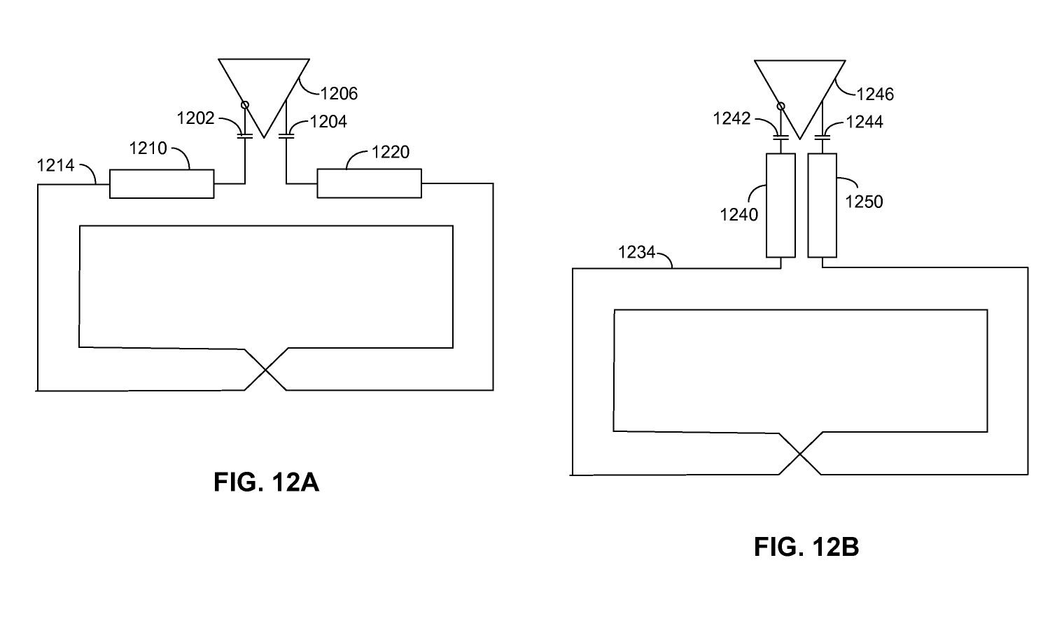

FIG. 12A is a diagram illustrating an exemplary embodiment of a transmit antenna 1214 that can be used with the wireless charging structures described herein. The transmit antenna 1214 is coupled to transmit circuitry 1206 via resonant capacitors 1202 and 1204. The transmit circuitry 1206 can be an embodiment of the transmit circuitry 406 described in FIG. 4. The transmit antenna 1214 is shown in FIG. 12A as a coil having two “turns” or “windings.” However, other configurations are possible. The resonant capacitors 1202 and 1204, together with the transmit antenna 1214 may create a resonant structure at a desired resonant frequency. In the example shown in FIG. 12A, the resonant capacitors 1202 and 1204, together with the transmit antenna 1214 create a series-resonant circuit. However, in alternative embodiments, the resonant capacitors 1202 and 1204, and the transmit antenna 1214 may be coupled as a parallel-resonant circuit.

In an exemplary embodiment, the transmit antenna 1214 comprises capacitive structures 1210 and 1220. In an exemplary embodiment, the capacitive structures 1210 and 1220 can be formed using portions of the transmit antenna 1214. For example, the capacitive structures 1210 and 1220 can be formed by expanding the size of the windings of the transmit antenna 1214, or by adding conductive material to portions of the windings of the transmit antenna 1214. In an exemplary embodiment, the capacitive structures 1210 and 1220 may include additional material or material layers, such as a layer of insulator or dielectric material over some or all of the windings or conductive material of the capacitive structures 1210 and 1220. The transmit antenna 1214 may generate an electric field using the capacitive structures 1210 and 1220. The electric field generated by the capacitive structures 1210 and 1220 may be used for wireless capacitive power transfer as described above. Locating the capacitive structures 1210 and 1220 after the resonant capacitors 1202 and 1204, referred to as the “transmit side,” as shown in FIG. 12A, causes a high voltage signal to be present on the capacitive structures 1210 and 1220.

FIG. 12B is a diagram illustrating an exemplary embodiment of a transmit antenna 1234 that can be used with the wireless charging structures described herein. The transmit antenna 1234 is coupled to transmit circuitry 1246 via resonant capacitors 1242 and 1244. The transmit circuitry 1246 can be an embodiment of the transmit circuitry 406 described in FIG. 4. The transmit antenna 1234 is shown in FIG. 12B as a coil having two “turns” or “windings.” However, other configurations are possible. The resonant capacitors 1242 and 1244, together with the transmit antenna 1234 may create a resonant structure at a desired resonant frequency. In the example shown in FIG. 12B, the resonant capacitors 1242 and 1244, together with the transmit antenna 1234 create a series-resonant circuit. However, in alternative embodiments, the resonant capacitors 1242 and 1244, and the transmit antenna 1234 may be coupled as a parallel-resonant circuit.

In an exemplary embodiment, the transmit antenna 1234 comprises capacitive structures 1240 and 1250. The capacitive structures 1240 and 1250 can be similar to the capacitive structures 1210 and 1220, but can be oriented as shown in FIG. 12B. The size and shape of the capacitive structures 1210, 1220, 1240 and 1250 may be optimized for maximum area, moderate separation from each other (so they couple to corresponding metal plates in a charge-receiving device and not to each other) and minimal exposed area (i.e., area not covered by the corresponding metal plates in the charge-receiving device).

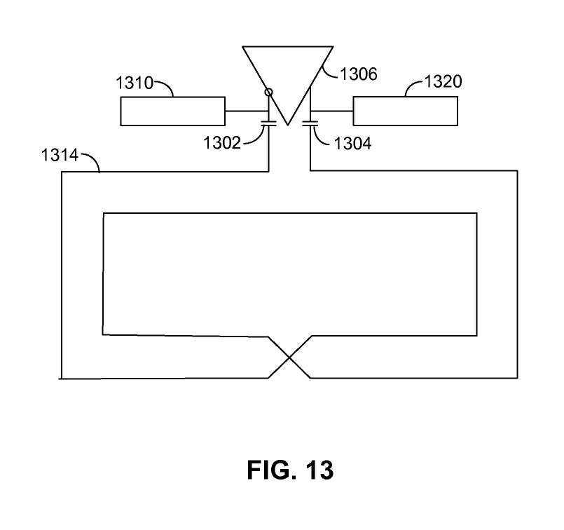

FIG. 13 is a diagram illustrating an exemplary embodiment of a transmit antenna 1314 that can be used with the wireless charging structures described herein. The transmit antenna 1314 is coupled to transmit circuitry 1306 via resonant capacitors 1302 and 1304. The transmit circuitry 1306 can be an embodiment of the transmit circuitry 406 described in FIG. 4. The transmit antenna 1314 is shown in FIG. 13 as a coil having two “turns” or “windings.” However, other configurations are possible. The resonant capacitors 1302 and 1304, together with the transmit antenna 1314 may create a resonant structure at a desired resonant frequency. In the example shown in FIG. 13, the resonant capacitors 1302 and 1304, together with the transmit antenna 1314 create a series-resonant circuit. However, in alternative embodiments, the resonant capacitors 1302 and 1304, and the transmit antenna 1314 may be coupled as a parallel-resonant circuit.

In an exemplary embodiment, the transmit antenna 1314 comprises capacitive structures 1310 and 1320. In an exemplary embodiment, the capacitive structures 1310 and 1320 can be formed using portions of the transmit antenna 1314. For example, the capacitive structures 1310 and 1320 can be formed by expanding the size of the metallic windings of the transmit antenna 1314, or by adding conductive material to portions of the windings of the transmit antenna 1314. In an exemplary embodiment, the capacitive structures 1310 and 1320 may include additional material or material layers, such as a layer of insulator or dielectric material over some or all of the windings or conductive material of the capacitive structures 1310 and 1320. The transmit antenna 1314 may generate an electric field using the capacitive structures 1310 and 1320. The electric field generated by the capacitive structures 1310 and 1320 may be used for wireless capacitive power transfer as described above. Locating the capacitive structures 1310 and 1320 before the resonant capacitors 1302 and 1304, referred to as the “receive side,” that is, between the output of the transmit circuitry 1306 and the resonant capacitors 1302 and 1304, causes a high voltage signal to be present on the corresponding capacitor plates of a charge-receiving device (not shown), and may be used as compared to the configuration shown in FIGS. 12A and 12B in some applications.

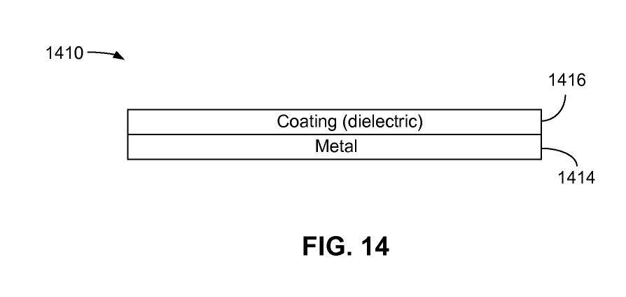

FIG. 14 is a schematic diagram showing an exemplary embodiment of a capacitive structure of FIG. 11, FIG. 12A, FIG. 12B and FIG. 13. In an exemplary embodiment, the capacitive structure 1410 comprises a metal or metallic portion 1414 and a coating 1416. In an exemplary embodiment, the metal portion 1414 may be a portion of the transmit antenna described above, or may be formed from the same material as the transmit antenna and added as an additional portion of a transmit antenna. In exemplary embodiment, the coating 1416 can be an insulator material, such as a dielectric material. In an application in which the capacitive structure 1410 is at a relatively high voltage, that is, when the capacitive structure 1410 is located between the resonant capacitors and the transmit antenna, it may be desirable to provide the coating 1416 to minimize any possible negative effects of having a high voltage on the capacitive structure 1410.

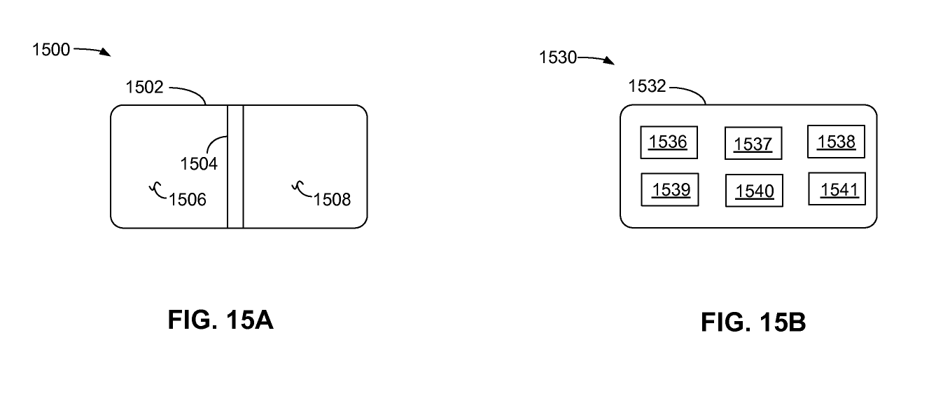

FIG. 15A is a schematic diagram showing an exemplary embodiment of a charge-receiving device 1500 configured to receive an electric field coupling. The charge-receiving device 1500 comprises a case 1502 having a first metal portion 1506 and a second metal portion 1508 separated by an insulator 1504. In an exemplary embodiment, the first metal portion 1506 may form one of the plates of a first capacitor, such as the metal plate 806 of the capacitor 810 (FIG. 8) and the second metal portion 1508 may form one of the plates of a second capacitor, such as the metal plate 808 of the capacitor 812 (FIG. 8). In an exemplary embodiment in which relatively high voltage is expected on the “receive side” (i.e., locating the capacitive structures between the transmit circuitry and the resonant capacitors) portions of the case 1502 may be covered with an insulator material, such as a dielectric material. In an exemplary embodiment, the charge-receiving device 1500 may be a tablet computing device, a large phone, or another charge-receiving device, and may have a metal cover or housing that could be divided to form the metal plate 806 and the metal plate 808 from portions of the metal cover or housing.

FIG. 15B is a schematic diagram showing an exemplary embodiment of a charge-receiving device 1530 configured to receive an electric field coupling. The charge-receiving device 1530 comprises a case 1532 having metal portions 1536, 1537, 1538, 1539, 1540 and 1541. In an exemplary embodiment, the metal portions 1536, 1537, 1538, 1539, 1540 and 1541 may form one of the plates of respective capacitors, such as the capacitors 810 and 812 (FIG. 8), with the multiple metal portions 1536, 1537, 1538, 1539, 1540 and 1541 creating multiple charging areas such that the placement location of the charge-receiving device 1530 on the wireless charging surface may not be critical.

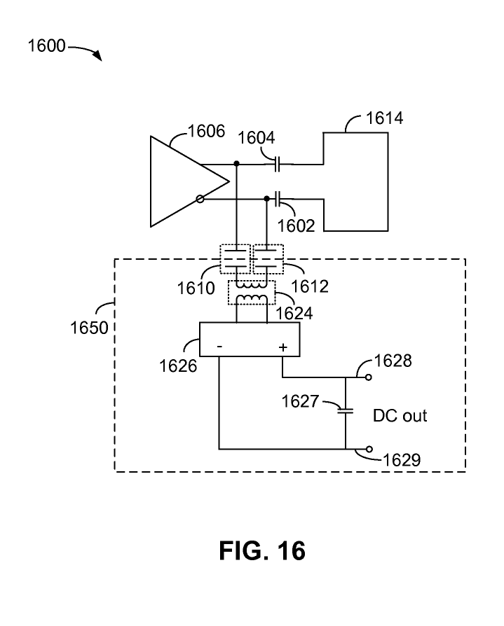

FIG. 16 is a schematic diagram showing an exemplary embodiment of a wireless charging system 1600. The wireless charging system 1600 comprises transmit circuitry 1606 coupled to a transmit antenna 1614 using resonant capacitors 1602 and 1604. The transmit circuitry 1606 can be an embodiment of the transmit circuitry 406 described in FIG. 4. The transmit antenna 1614 is shown in FIG. 16 as a simplified coil having one “turn” or “winding” for simplicity only. However, other configurations are possible. The resonant capacitors 1602 and 1604, together with the transmit antenna 1614 may create a resonant structure at a desired resonant frequency. In the example shown in FIG. 16, the resonant capacitors 1602 and 1604, together with the transmit antenna 1614 create a series-resonant circuit. However, in alternative embodiments, the resonant capacitors 1602 and 1604, and the transmit antenna 1614 may be coupled as a parallel-resonant circuit. In an exemplary embodiment, the resonant capacitors 1602 and 1604, and the transmit antenna 1614 are configured to provide wireless inductive power transfer.

The wireless charging system 1600 also comprises a charge-receiving device 1650. The charge-receiving device 1650 can be an embodiment of the receiver 508 shown in FIG. 5. Details of the charge-receiving device 1650 are omitted from FIG. 16 for simplicity of illustration. An inductive receive antenna is not shown in the charge-receiving device 1650 of FIG. 16 for simplicity of illustration. To allow capacitive charging, in an exemplary embodiment, the transmit antenna 1614 may be coupled to the charge-receiving device 1650 using coupling capacitors 1610 and 1612. One plate of each of the coupling capacitors 1610 and 1612 is associated with or coupled to the transmit antenna 1614 or the transmit circuitry 1606. The other plate of the coupling capacitors 1610 and 1612 is associated with or coupled to the charge-receiving device 1650. The coupling capacitors 1610 and 1612 allow an electric field (E-field) coupling to be established between the transmit circuitry 1606 and the charge-receiving device 1650. In an exemplary embodiment, the coupling capacitors 1610 and 1612 can be coupled to the “low voltage” output of the transmit circuitry 1606, i.e., “before” the resonant capacitors 1602 and 1604. This arrangement results in a “low voltage” being present on the “transmit” side of the coupling capacitors 1610 and 1612 and a “high voltage” being present on the “receive” side of the coupling capacitors 1610 and 1612. In an alternative exemplary embodiment, the coupling capacitors 1610 and 1612 can be coupled to the “high voltage” output of the transmit circuitry 1606, i.e., “after” the resonant capacitors 1602 and 1604. This arrangement results in a “high voltage” being present on the “transmit” side of the coupling capacitors 1610 and 1612 and a “low voltage” being present on the “receive” side of the coupling capacitors 1610 and 1612.

In an exemplary embodiment, the charge-receiving device 1650 also comprises a transformer 1624, and a rectifier circuit 1626, which provides a DC output over connections 1628 and 1629. A capacitor 1627 filters the DC output.

In the embodiment shown in FIG. 16, the coupling capacitors 1610 and 1612 are coupled to the low voltage AC output of the transmit circuitry 1606. The transformer 1624 converts the AC output from the coupling capacitors 1610 and 1612 to a low voltage, high current AC signal for input to the rectifier circuit 1626. The rectifier circuit 1626 converts the output of the transformer 1624 to the desired DC voltage, the capacitor 1627 provides a filter function, and the DC output is provided over connections 1628 and 1629. Alternatively, the coupling capacitors 1610 and 1612 could be coupled to the high voltage (low current) AC output of the resonant capacitors 1602 and 1604.

The leakage inductance of the transformer 1624 may be coupled with the capacitance provided by the coupling capacitors 1610 and 1612 to form a resonant circuit in the charge-receiving device 1650. The resonant circuit provided by the coupling capacitors 1610 and 1612 and the leakage inductance of the transformer 1624 forms a resonant inductive-capacitive (LC) circuit which increases coupling through the coupling capacitors 1610 and 1612. The transformer 1624 matches the real impedance of the charge-receiving device 1650 to the driving impedance of the transmit circuitry 1606. This arrangement accommodates of a wide range of charging voltages and currents without a reduction in power transfer, and is accomplished by changing the ratio of the turns in the primary and secondary sides of the transformer 1624.

The charge-receiving device 1650 may be a larger device, such as tablet computing device or the like because a larger device may have more space for a transformer, such as the transformer 1624. However, smaller devices may be able to accommodate the transformer 1624 as well.

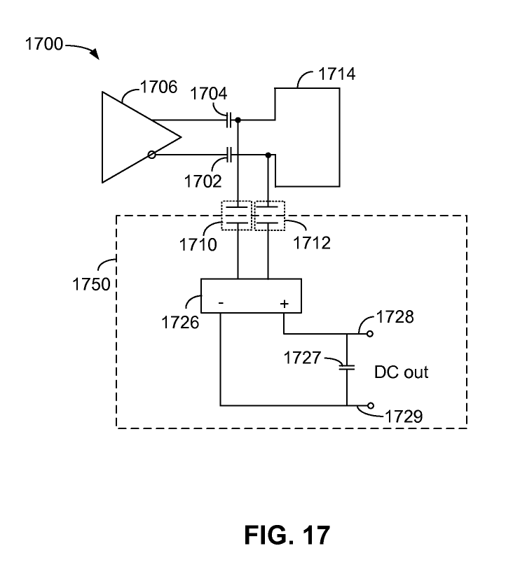

FIG. 17 is a schematic diagram showing an exemplary embodiment of a wireless charging system 1700. The wireless charging system 1700 comprises transmit circuitry 1706 coupled to a transmit antenna 1714 using resonant capacitors 1702 and 1704. The transmit circuitry 1706 can be an embodiment of the transmit circuitry 406 described in FIG. 4. The transmit antenna 1714 is shown in FIG. 17 as a simplified coil having one “turn” or “winding” for simplicity only. However, other configurations are possible. The resonant capacitors 1702 and 1704, together with the transmit antenna 1714 may create a resonant structure at a desired resonant frequency. In the example shown in FIG. 17, the resonant capacitors 1702 and 1704, together with the transmit antenna 1714 create a series-resonant circuit. However, in alternative embodiments, the resonant capacitors 1702 and 1704, and the transmit antenna 1714 may be coupled as a parallel-resonant circuit. In an exemplary embodiment, the resonant capacitors 1702 and 1704, and the transmit antenna 1714 are configured to provide inductive wireless power transfer. In the exemplary embodiment shown in FIG. 17, the coupling capacitors 1710 and 1712 are coupled to the high voltage (low current) AC output of the resonant capacitors 1702 and 1704. However, in another exemplary embodiment, the coupling capacitors 1710 and 1712 could be coupled to the low voltage AC output of the transmit circuitry 1706, similar to that shown in FIG. 16.

The wireless charging system 1700 also comprises a charge-receiving device 1750. The charge-receiving device 1750 can be an embodiment of the receiver 508 shown in FIG. 5. Details of the charge-receiving device 1750 are omitted from FIG. 17 for simplicity of illustration. An inductive receive antenna is not shown in the charge-receiving device 1750 of FIG. 17 for simplicity of illustration. To allow capacitive charging, in an exemplary embodiment, the transmit antenna 1714 may be coupled to the charge-receiving device 1750 using coupling capacitors 1710 and 1712. One plate of each of the coupling capacitors 1710 and 1712 is associated with or coupled to the transmit antenna or the transmit circuitry 1706. The other plate of the coupling capacitors 1710 and 1712 is associated with or coupled to the charge-receiving device 1750. The coupling capacitors 1710 and 1712 allow an electric field (E-field) coupling to be established between the transmit circuitry 1706 and the charge-receiving device 1750. In an exemplary embodiment, the coupling capacitors 1710 and 1712 are coupled to the “high voltage” output of the transmit circuitry 1706, i.e., “after” the resonant capacitors 1702 and 1704. This arrangement results in a “high voltage” being present on the “transmit” side of the coupling capacitors 1710 and 1712 and a “low voltage” being present on the “receive” side of the coupling capacitors 1710 and 1712.

In an exemplary embodiment, the charge-receiving device 1750 also comprises a rectifier circuit 1726, which provides a DC output over connections 1728 and 1729 and capacitor 1727.

The rectifier circuit 1726 converts the AC output of the coupling capacitors 1710 and 1712 to the desired DC voltage, the capacitor 1727 provides a filter function, and the DC output is provided over connections 1728 and 1729.

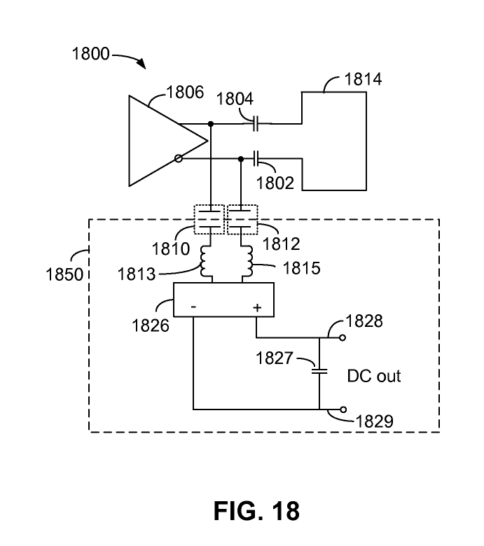

FIG. 18 is a schematic diagram showing an exemplary embodiment of a wireless charging system 1800. The wireless charging system 1800 comprises transmit circuitry 1806 coupled to a transmit antenna 1814 using resonant capacitors 1802 and 1804. The transmit circuitry 1806 can be an embodiment of the transmit circuitry 406 described in FIG. 4. The transmit antenna 1814 is shown in FIG. 18 as a simplified coil having one “turn” or “winding” for simplicity only. However, other configurations are possible. The resonant capacitors 1802 and 1804, together with the transmit antenna 1814 may create a resonant structure at a desired resonant frequency. In the example shown in FIG. 18, the resonant capacitors 1802 and 1804, together with the transmit antenna 1814 create a series-resonant circuit. However, in alternative embodiments, the resonant capacitors 1802 and 1804, and the transmit antenna 1814 may be coupled as a parallel-resonant circuit. In an exemplary embodiment, the resonant capacitors 1802 and 1804, and the transmit antenna 1814 are configured to provide inductive wireless power transfer.

The wireless charging system 1800 also comprises a charge-receiving device 1850. The charge-receiving device 1850 can be an embodiment of the receiver 508 shown in FIG. 5. Details of the charge-receiving device 1850 are omitted from FIG. 18 for simplicity of illustration. An inductive receive antenna is not shown in the charge-receiving device 1850 of FIG. 18 for simplicity of illustration. To allow capacitive charging, in an exemplary embodiment, the transmit antenna 1814 may be coupled to the charge-receiving device 1850 using coupling capacitors 1810 and 1812. One plate of each of the coupling capacitors 1810 and 1812 is associated with or coupled to the transmit antenna or the transmit circuitry 1806. The other plate of the coupling capacitors 1810 and 1812 is associated with or coupled to the charge-receiving device 1850. The coupling capacitors 1810 and 1812 allow an electric field (E-field) coupling to be established between the transmit circuitry 1806 and the charge-receiving device 1850. In an exemplary embodiment, the coupling capacitors 1810 and 1812 are coupled to the “low voltage” output of the transmit circuitry 1806, i.e., “before” the resonant capacitors 1802 and 1804. This arrangement results in a “low voltage” being present on the “transmit” side of the coupling capacitors 1810 and 1812 and a “high voltage” being present on the “receive” side of the coupling capacitors 1810 and 1812.

In an exemplary embodiment, the charge-receiving device 1850 also comprises resonant inductors 1813 and 1815, and a rectifier circuit 1826, which provides a DC output over connections 1828 and 1829 and capacitor 1827.

In the embodiment shown in FIG. 18, the coupling capacitors 1810 and 1812 are coupled to the low voltage (high current) output of the transmit circuitry 1806. The resonant inductors 1813 and 1815 and the coupling capacitors 1810 and 1812 create a resonant circuit that resonates at the fundamental power transfer frequency. The rectifier circuit 1826 converts the output of the coupling capacitors 1810 and 1812 to the desired DC voltage, the capacitor 1827 provides a filter function, and the DC output is provided over connections 1828 and 1829.

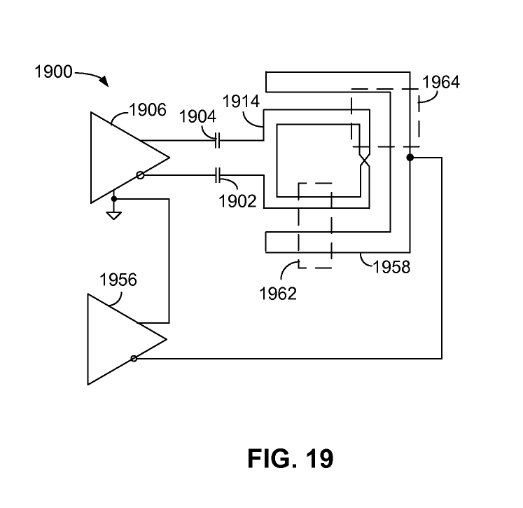

FIG. 19 is a schematic diagram showing an exemplary embodiment of a wireless power transmitter 1900. The wireless power transmitter 1900 comprises transmit circuitry 1906 coupled to a transmit antenna 1914 using resonant capacitors 1902 and 1904. The transmit circuitry 1906 can be an embodiment of the transmit circuitry 406 described in FIG. 4. The transmit antenna 1914 is shown in FIG. 19 as a simplified coil having two “turns” or “windings” for simplicity only. However, other configurations are possible. The resonant capacitors 1902 and 1904, together with the transmit antenna 1914 may create a resonant structure at a desired resonant frequency. In the example shown in FIG. 19, the resonant capacitors 1902 and 1904, together with the transmit antenna 1914 create a series-resonant circuit. However, in alternative embodiments, the resonant capacitors 1902 and 1904, and the transmit antenna 1914 may be coupled as a parallel-resonant circuit. In an exemplary embodiment, the resonant capacitors 1902 and 1904, and the transmit antenna 1914 are configured to provide inductive wireless power transfer.

In an exemplary embodiment, the wireless power transmitter 1900 comprises additional transmit circuitry 1956 coupled to a metal plate 1958. In an exemplary embodiment, it may be advantageous to use two transmit circuits to generate power, one transmit circuit for generating an electric field (E-field) coupling, and one transmit circuit for generating a magnetic field (H-field) coupling. In an exemplary embodiment, in a first mode in which the transmit circuitry 1906 drives the transmit antenna 1914 using a differential signal, the transmit circuitry 1906 is used to generate a magnetic field (H-field) coupling using the transmit antenna 1914 and the resonant capacitors 1902 and 1904. In a second mode the additional transmit circuitry 1956 is used to swing the common mode of the transmit circuitry 1906 to generate a common mode signal between the transmit antenna 1914 (the H-field resonator) and a second conductor, such as the metal plate 1958. In an exemplary embodiment, the metal plate 1958 is located outside the periphery of the transmit antenna 1914. In this manner, the transmit antenna 1914 becomes one of the plates of a first capacitor that can be used to establish an electric field (E-field) coupling and the metal plate 1958 becomes one of the plates of a second capacitor that can be used to establish an electric field (E-field) coupling, similar to that described above in FIG. 9, with a difference being that in FIG. 19, the transmit antenna 1914 is driven by transmit circuitry 1906 and the metal plate 1958 is driven by the additional transmit circuitry 1956. The differential mode and the common mode are independent in that either mode can work without the other mode, or the differential mode and the common mode can work simultaneously.

This arrangement has several advantages including, for example, the H-field transmit circuitry 1906 and the E-field transmit circuitry 1956 can be on or off in any combination. The H-field transmit circuitry 1906 and the E-field transmit circuitry 1956 can be used simultaneously if desired. The H-field transmit circuitry 1906 and the E-field transmit circuitry 1956 may operate at different frequencies. For example, a higher frequency may be desirable for wireless capacitive power transfer than for wireless inductive power transfer. For example, a system configured for wireless inductive power transfer may operate at 6.78 MHz and a system configured for wireless capacitive power transfer may operate at 13.56 MHz. The area that can be used to charge a charge-receiving device using the embodiment of FIG. 19 is large. A charge-receiving device that is placed across both the transmit antenna 1914 and the metal plate 1958, for example, will charge if the charge-receiving device has metal plates corresponding to the transmit antenna 1914 and the metal plate 1958 to form capacitors, as described above. For example, charge-receiving devices 1962 and 1964 can be located anywhere on the surface of a charging pad that is encompassed by the transmit antenna 1914 and the metal plate 1958. The receiver in the charge-receiving device placed in proximity to the transmit antenna 1914 and the metal plate 1958 can contain two plates that form the receiver plates of the capacitors. It is desirable to maximize the overlap between the transmit antenna 1914 and one of the metal plates (not shown) in the receiver (not shown), and also maximize the overlap between the metal plate 1958 and the corresponding metal plate (not shown) in the receiver (not shown). Generally, this entails positioning the receiver so that the line of separation between the two plates in the receiver align with the line of separation between the transmit antenna 1914 and the metal plate 1958.

Although exemplary embodiments described herein show resonant structures (e.g., for inductive power transfer), alternative embodiments may equally apply to non-resonant implementations (e.g., inductive power transfer only).

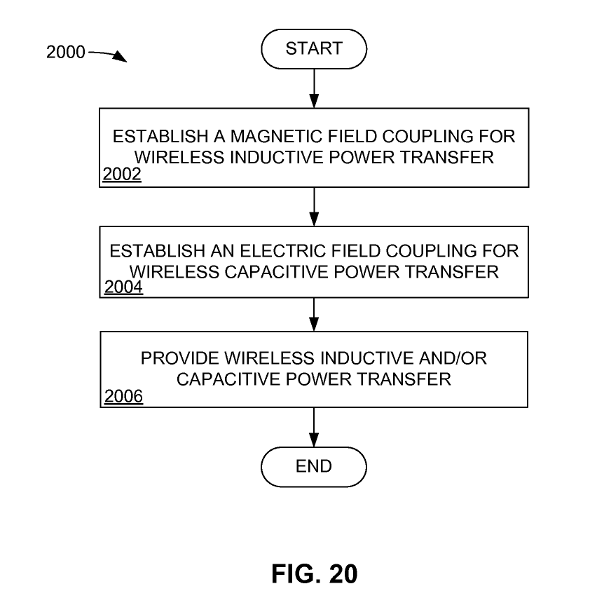

FIG. 20 is a flowchart illustrating an exemplary embodiment of a method 2000 for wireless inductive and capacitive power transfer. The blocks in the method 2000 can be performed in or out of the order shown. The description of the method 2000 will relate to the various embodiments described herein.

In block 2002, a magnetic field coupling is established for wireless inductive power transfer.

In block 2004, an electric field coupling is established for wireless capacitive power transfer.

In block 2006, wireless inductive and/or capacitive power transfer is provided.

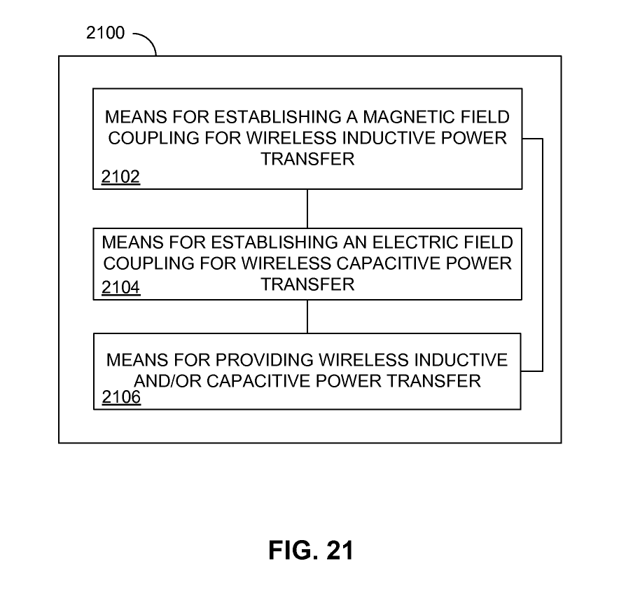

FIG. 21 is a functional block diagram of an apparatus 2100 for wireless inductive and capacitive power transfer. The apparatus 2100 comprises means 2102 for establishing a magnetic field coupling for wireless inductive power transfer. In certain embodiments, the means 2102 for establishing a magnetic field coupling for wireless inductive power transfer can be configured to perform one or more of the function described in operation block 2002 of method 2000 (FIG. 20). In an exemplary embodiment, the means 2102 for establishing a magnetic field coupling for wireless inductive power transfer may comprise the transmit antenna and transmit circuitry described herein.

The apparatus 2100 further comprises means 2104 for establishing an electric field coupling for wireless capacitive power transfer. In certain embodiments, the means 2104 for establishing an electric field coupling for wireless capacitive power transfer can be configured to perform one or more of the function described in operation block 2004 of method 2000 (FIG. 20). In an exemplary embodiment, the means 2104 for establishing an electric field coupling for wireless capacitive power transfer may comprise the coupling capacitors described herein.

The apparatus 2100 further comprises means 2106 for providing wireless inductive and/or capacitive power transfer. In certain embodiments, the means 2106 for providing wireless inductive and/or capacitive power transfer can be configured to perform one or more of the function described in operation block 2006 of method 2000 (FIG. 20). In an exemplary embodiment, the means 2106 for providing wireless inductive and/or capacitive power transfer may comprise the transmit antenna and transmit circuitry described herein and the coupling capacitors and related circuitry described herein.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

1. A wireless power transfer system, comprising:
an inductive transmit antenna; and
a capacitive power transfer element, the inductive transmit antenna and the capacitive power transfer element configured to selectively provide inductive power transfer and selectively provide capacitive power transfer.

2. The wireless power transfer system of claim 1, wherein the inductive transmit antenna is configured to provide inductive power transfer and the capacitive power transfer element is simultaneously configured to provide capacitive power transfer.

3. The wireless power transfer system of claim 1, wherein the inductive transmit antenna is configured to provide inductive power transfer independently from the capacitive power transfer element being configured to provide capacitive power transfer.

4. The wireless power transfer system of claim 1, wherein the inductive transmit antenna is configured to provide inductive power transfer in a first mode and is configured to provide capacitive power transfer in a second mode.

5. The wireless power transfer system of claim 1, wherein the capacitive power transfer element comprises a metal capacitor plate configured to provide an electric field coupling.

6. The wireless power transfer system of claim 1, wherein the capacitive power transfer element comprises at least one inherently capacitive portion of the inductive transmit antenna.

7. The wireless power transfer system of claim 1, wherein the capacitive power transfer element comprises at least one capacitive portion of at least a part of the inductive transmit antenna.

8. The wireless power transfer system of claim 7, wherein the at least one capacitive portion of at least a part of the inductive transmit antenna further comprises an insulator.

9. The wireless power transfer system of claim 1, wherein the capacitive power transfer element comprises a selectively conductive material that can be switched between an electrically conductive state and an electrically non-conductive state, the selectively conductive material configured to selectively provide capacitive power transfer when conductive.

10. The wireless power transfer system of claim 1, further comprising:
a wireless power receiver having an inductive receive antenna; and
the wireless power receiver having a capacitive power transfer element, the wireless power receiver configured to receive inductive power and capacitive power.

11. The wireless power transfer system of claim 1, further comprising a ferrite element positioned between the inductive transmit antenna and the capacitive power transfer element.

12. The wireless power transfer system of claim 1, wherein the capacitive power transfer element comprises two separated capacitive elements in a wireless charging structure.

13. The wireless power transfer system of claim 12, wherein the wireless charging structure further comprises a wireless charging surface configured to receive a charge-receiving device, the inductive transmit antenna configured to generate a magnetic field for charging the charge-receiving device positioned on the wireless charging surface, and the capacitive power transfer element forms a capacitive charging area on the wireless charging surface.

14. The wireless power transfer system of claim 12, further comprising at least two respective capacitors coupled to the inductive transmit antenna, and the two separated capacitive elements are coupled to one of a first side and a second side of the respective capacitors, the first side having a higher voltage than the second side.

15. The wireless power transfer system of claim 1, wherein the inductive transmit antenna is driven with a signal configured to generate a magnetic field for coupling power inductively at a level sufficient for charging a charge-receiving device.

16. The wireless power transfer system of claim 1, wherein the capacitive power transfer element is driven with a signal configured to generate an electric field for coupling power capacitively at a level sufficient for charging a charge-receiving device.

17. The wireless power transfer system of claim 1, further comprising transmit circuitry configured to selectively control the inductive transmit antenna and the capacitive power transfer element to selectively provide inductive power transfer and selectively provide capacitive power transfer.

18. A wireless power transfer system, comprising:
an inductive transmit antenna coupled to a first transmit circuit; and
a first capacitive power transfer element coupled to a second transmit circuit, the inductive transmit antenna and the first capacitive power transfer element configured to selectively provide inductive power transfer and selectively provide capacitive power transfer, wherein in a first mode the inductive transmit antenna is configured to provide inductive power transfer and in a second mode the second transmit circuit is configured to alter a common mode of the first transmit circuit to generate a common mode signal between the inductive transmit antenna and the first capacitive power transfer element, the inductive transmit antenna being configured as a second capacitive power transfer element.

19. The wireless power transfer system of claim 18, wherein the first capacitive power transfer element comprises a metal plate located outside of a periphery of the inductive transmit antenna.

20. The wireless power transfer system of claim 19, wherein the inductive transmit antenna becomes a first plate of a first capacitor that can be configured to establish an electric field coupling and the first capacitive power transfer element becomes a first plate of a second capacitor that can be configured to establish an electric field coupling.

21. The wireless power transfer system of claim 20, further comprising:
a wireless power receiver having an inductive receive antenna; and
a first receiver capacitive power transfer element forming another plate of the first capacitor; and
a second receiver capacitive power transfer element forming another plate of the second capacitor.

22. A device for wireless power transfer, comprising:
means for establishing a magnetic field coupling for selectively providing inductive power transfer;
means for establishing an electric field coupling for selectively providing capacitive power transfer; and
means for selectively providing inductive power transfer and capacitive power transfer.

23. The device of claim 22, further comprising means for simultaneously providing inductive power transfer and capacitive power transfer.

24. The device of claim 22, further comprising means for independently providing inductive power transfer and capacitive power transfer.

25. The device of claim 22, further comprising means for using a portion of the means for selectively providing inductive power transfer as the means for establishing the electric field coupling.

26. The device of claim 22, further comprising means for controlling an electrical conductivity of a selectively conductive material to selectively provide capacitive power transfer when conductive.

27. A method for wireless power transfer, comprising:
establishing a magnetic field coupling for selectively providing inductive power transfer;
establishing an electric field coupling for selectively providing capacitive power transfer; and
selectively providing inductive power transfer and capacitive power transfer.

28. The method of claim 27, further comprising simultaneously providing inductive power transfer and capacitive power transfer.

29. The method of claim 27, further comprising independently providing inductive power transfer and capacitive power transfer.

30. The method of claim 27, further comprising using a selectively conductive material to selectively provide capacitive power transfer when conductive.
